(19) United States
(12) Patent Application Publication
(10) Pub. No.: US 2026/0245142 A1
(43) Pub. Date: Aug. 20, 2026

(54) SYSTEM AND METHOD FOR USING MERCHANT FINGERPRINTS TO LINK PRIMARY ACCOUNT NUMBERS (PANS) TO THE SAME USER

(71) Applicant: MASTERCARD INTERNATIONAL INCORPORATED, Purchase, NY (US)

(72) Inventors: Wally F LO FARO, St Louis, MO (US); Meghana SANTHAPUR, Lake Saint Louis, MO (US)

(73) Assignee: MASTERCARD INTERNATIONAL INCORPORATED, Purchase, NY (US)

(21) Appl. No.: 19/057,662

(22) Filed: Feb. 19, 2025

(51) Int. Cl. G06Q 40/02; G06F 16/28

(52) U.S. Cl. CPC G06Q 40/02; G06F 16/288

(57) ABSTRACT

The disclosure relates to a new solution for determining and two primary account numbers (PANs) that belong to the same user through generating new relationships in a graph database. A graph database stores information in nodes and edges connecting the nodes, where the edges between the nodes represent some kind of relationship between the nodes. A baseline PAN stored in the relational database may be accessed and used to create a baseline node in the graph database. Then, all other PANs in the relational database that were created after the baseline PAN ceased transactional activity may used to create other nodes in the graph database. A measure of similarity of spending patterns between the baseline PAN and each new PAN may be generated in the edges, and the edge with the highest similarity may point to the new PAN that was made by the same user as the baseline PAN.

### BACKGROUND

Often, a consumer relies on one payment card to conduct most transactions, due to convenience. These top-of-wallet cards usually offer some of the best benefits for the consumer, and it may be the most convenient for the consumer to create other conveniences from, like automatic payments or automatic reward point conversions. From time to time, the consumer may change payment cards for one or more reasons, yet the automatic billing or other automated processes have to be manually redone usually, once this changeover occurs. Financial institutions may also want to determine if the consumer switches from one main top of wallet card to another, but it is not trivial to determine this without being explicitly informed by the consumer. It is desirable to find ways to link two payment cards to a single user in an automated fashion using the existing information available to various financial institutions.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment 100 of determining and then linking two PANs that belong to the same user through generating new relationships in a graph database;

FIG. 2 illustrates an example scenario of a user's transactional spending patterns that provides context for how a GCG device may generate graph database components to link the user's different accounts together;

FIG. 3 shows a schematic of example details in relational database that corresponds to the example scenario shown in FIG. 2;

FIG. 4 shows several nodes and edges of an example graph database that can be used by a device to help determine if two transactional accounts should be linked to the same user, according to some embodiments;

FIG. 5 illustrates an example of a method for generating components in a graph database to determine a measure of similarity between a baseline transactional account and one or more new transactional accounts, according to some embodiments; and

FIG. 6 illustrates an example of a computer system that may be implemented by devices illustrated in FIG. 1.

### DETAILED DESCRIPTION

The disclosure relates to methods and systems of a graph component generator (GCG) computing device configured to generate relationships between nodes in a graph database populated with transactional accounts of users. A transactional account of a user represents a collection of financial transactions that a user makes with some unique identifying payment medium, such as a credit card or a debit card, whether it be digital or physical, that can interact with multiple merchants. Each transactional account may be linked to a unique Primary Account Number (PAN). The GCG device may be configured to generate a relationship between nodes in a graph database, where each node represents a transactional account. The relationship between the nodes may include a measure of similarity between the nodes, based on how similar the transactional spending patterns are of the nodes. The spending pattern of a transactional account may be based on which merchants the transactional account has engaged with over a period of time, how frequent the engagement is and/or how much is being spent with each merchant. The GCG device may also be configured to determine whether the two nodes are in reference to the same user—meaning the user has been using two different transactional accounts—based on if the measure of similarity between the two nodes satisfies some similarity threshold or other determinative factor. The GCG device may be configured to transmit to a separate requesting device any or all of this information and/or may be configured to cause display of this information for a user to analyze. In this way, the GCG device may be able to link two transactional accounts to the same user when the two accounts would be otherwise treated as independent of each other.

Often, a user's spending habits tend toward the user relying on a single payment card tied to one PAN for most spending, and then using other payment cards tied to other PANs associated with other transactional accounts only sporadically and for infrequent, narrow reasons. The payment card that is used most often may be referred to as a “top of wallet” card. From time to time, a user may switch to another top of wallet card and continue his or her usual spending patterns using the new top of wallet card. Reasons for switching may include the user losing the original top of wallet card, the user deciding to switch to a different payment card that offers better benefits, or the original top of wallet payment card expiring and the user needs to switch to a newly issued replacement card. Even if the card is not a top of wallet card in that the user uses the card less frequently, the user may switch to another card similarly due to the card expiring, fraud and the like. To a common processing network, such as a Mastercard or Visa network, that would handle payment transactions of the original top of payment card and the new payment card, it is not always the case that the two PANs tied to their respective payment cards are linked to the same user. This may be because the new payment card may have been issued by a different card issuer—such as a different bank or a different merchant—or the user moves to a new country, as just a couple examples. The processing network may not also be linking new cards that are issued to the user due to fraud or expiration. In general, the processing network may not know or store the cardholder's name, address, and other identifying information that would allow the processing network to link two cards to the same user by simply matching the identifying information.

However, it may be beneficial for the processing network to be able to link two independent PANs together if they were/are used by the same person. For example, linking a second PAN to the same user of an earlier used PAN may make it easier to set up automatic payments or updates. As another example, any past history that provided benefits to the user through the first PAN may then be applied to the second PAN if the two PANs can be linked to the same person. This may include carrying over reward or loyalty points provided by the processing network and not just an isolated issuer, or offering more targeted deals based on the user's past history. Another example can be making it easier for law enforcement to find fraud and identify victims. As yet another example, when a new card is issued due to a fraud report, security algorithms may initiate undesirable false positive declines of the use of the issued replacement card if the user is not successfully linked to the issued replacement card. This can frustrate the user to the point of causing the user to cancel the card altogether.

The conventional means for storing PAN data and merchant data provide very poor ability to successfully link two independent PANs together, particularly at a scale of data that processing networks have to manage. Usually, information about PANs and merchants that engage in transactional activity with any number of the PANs are stored in a relational database. These types of databases usually store each PAN separately and tie various facts about each PAN to the PAN in an array in some manner. The relational database may include biographical data of the user associated with the PAN and merchant transactional history and/or geographical data related to locations of where the PAN is used, as some examples of the various facts. Each PAN is stored separately, as only the various facts associated with the PAN are linked to the PAN itself. No information across PANs can be linked to other PANs. While it is possible for there to be common information between two PANs stored in the relational database, the relational database does not store or have any way to store any metadata that establishes a connection between two different PANs.

The relational database may also similarly store merchant information in the same way. A unique merchant identification (MID) may uniquely identify each merchant that is in the processing network, and each MID may be stored as separate entries in the relational database. Various facts may be stored and tied to each MID entry, including biographical information about the merchant, location, type, and/or a transactional history of every transaction made with the merchant by all PANs that transacted with the merchant, as some possible examples. Each MID is stored separately, as only the various facts associated with the MID are linked to the MID itself. No information across MIDs can be linked to other MIDs.

The structure of the relational database disfavors any reasonable methods for trying to link PANs together to the same user, particularly at the size and scale of the relational database that a processing network would typically hold such information. This is discussed more below.

Instead, aspects of the present disclosure provide a new solution for determining and then linking two PANs that belong to the same user through generating new relationships in a graph database using a GCG device. A graph database stores information in nodes and edges connecting the nodes, where the edges between the nodes represent some kind of common information between the nodes. In some embodiments, the GCG device may be configured to access a baseline PAN stored in the relational database. The baseline PAN is a PAN that is to be compared against all other PANs. In one example, the baseline PAN may be associated with an initial top of wallet payment card that the user previously used to for most spending, until the user switched PANs for whatever reason. The GCG device may use the baseline PAN to create a baseline node in the graph database. Then, the GCG device may access all other PANs in the relational database that satisfy some common criteria. For example, the common criteria may be all new PANs that were created only after the user stopped using the baseline PAN, as determined by the PAN's merchant transaction activity. This may signify that the GCG device is trying to find all PANs that were opened after something happened to the baseline PAN that caused the baseline PAN to no longer be used, for example. The GCG device may create multiple nodes in the graph database, one for each new PAN that was determined to satisfy the common criteria (such as all new PANs that were opened after the last time the user used the baseline PAN). Then, the GCG device may access the MID transactional history of the baseline PAN and each of the transactional histories of each new PAN. The GCG may then generate an edge between the baseline node and each new node, where each edge includes the combination of the baseline PAN's transactional history and the new PAN's transactional history.

Generally, the GCG device may want to find the MID transactional history of a new PAN that is most similar to the baseline MID transactional history. This may signify that the user began using a new PAN to perform the same general pattern of spending, since the user stopped using the baseline PAN for whatever reason. The GCG device may determine which new PAN is the account used by the user after the baseline PAN stopped being used, by examining the information stored in each edge of the graph database, rather than the nodes. The GCG device may accomplish this by computing a measure of similarity of the MID information in each edge; that is, a measure of similarity may be computed for each pair of the baseline MID transactional history and one of each of the new MID transactional histories. The edge with the highest measure of similarity may be determined to have the two nodes that should be linked to the same user. Alternatively, if one or more edges have measures of similarity that satisfy a similarity threshold, those edges may be candidates for having nodes that should be linked to the same user. These details will be discussed more in the description of the figures below.

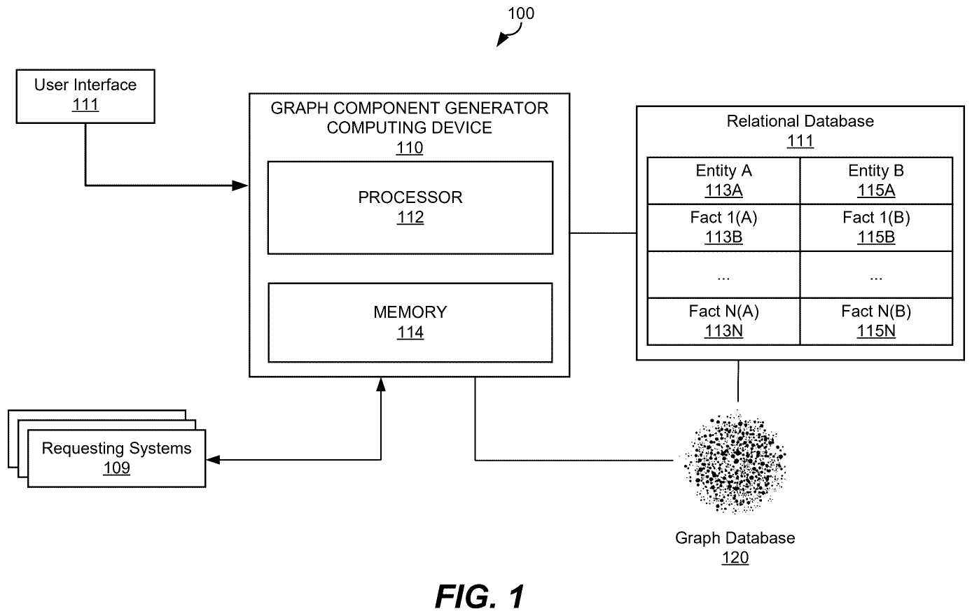

FIG. 1 illustrates an example of a system environment 100 of determining and then linking two PANs that belong to the same user through generating new relationships in a graph database. The system environment 100 may include a graph component generator (GCG) computing device 110, a user interface 111 for interacting with the GCG device 110, a relational database 111, a graph database 120, one or more requesting systems 109, and/or other components. At least some of the components of the system environment 100 may be connected to one another via a communication network, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

A GCG device 110 is a computer or application that is capable of accessing both a relational database 111 and a graph database 120, and building the graph database 120 with the information contained in the relational database 111. The GCG device 110 is also capable of analyzing the graph database 120 to provide conclusions about it to one or more requesting systems 109. The GCG device 110 includes a processor 112 and a memory 114 configured to perform at least these tasks.

The processor 112 may be a semiconductor-based microprocessor, a central processing unit (CPU), an application specific integrated circuit (ASIC), a field-programmable gate array (FPGA), and/or other suitable hardware device. Although the GCG device 110 has been depicted as including a single processor 112, it should be understood that the GCG device 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

The user interface 111 may provide means for a user to instruct the GCG device 110 on how to build the graph database 120, make determinations based on the information in the graph database 120, and/or transmit the information to the requesting systems 109. The user interface may include a graphical user interface and/or an application program interface (API) to allow a user to provide inputs to instruct the GCG device 110. A user such as a developer may operate the GCG device 110 through the user interface 111 on how to access the relational database 111 and generate components in the graph database 120.

The relational database 111 stores data in a specific but conventional format used by the GCG device 110 to extract information about various transactional accounts and merchants. Typically, a relational database 111 stores information by separate entities A, B, and so on. Each entity may be a separate object or person, such as a transactional account or different types of merchants. As an example, FIG. 1 shows the relational database including entity A 113A and entity B 115A, but of course it can contain many more entities. The relational database may not provide any data relating the two entities 113A and 115A together, but may tie to each entity various facts about the entity. For example, Fact 1(A) 113B through Fact N(A) 113N may be various facts tied to the entity A 113A in the relational database and may be stored as an array or a linked list linked to the entity A 113A, as just some examples. Fact 1(B) 115B through Fact N(B) 115N may be various facts tied to the entity B 115A in the relational database and may be stored as an array or a linked list linked to the entity B 115A, as just some examples. Examples of types of these facts in the context of this disclosure will be described in more detail below.

The graph database 120 is a type of database that stores information in the form of nodes and vertices connecting the nodes, which may be referred to as edges. Each node in the graph database may represent some kind of object, person, or location, while the edges contain information that relate the two connecting nodes together. A node may have any number of edges connected to it, such that a single node may have any number of other nodes connected to it via each respective connecting edge. The organizational structure of this type of database is called a graph database because this structure lends itself to the database being visualized like a web of nodes with connecting edges. Further example descriptions of the graph database 120 may be found in U.S. Pat. No. 10,528,958, patented Jan. 7, 2020, which is incorporated herein by reference.

A requesting system 109 is a computer or application that requests an outcome to be generated based on input data. The GCG device 110 may analyze or update the graph database 120, based on the input data received, to generate an outcome. For example, the GCG device 110 may combine facts from two different entities (e.g., Entity A 113A and Entity B 115A) to build edges in the graph database 120 between these two entities, which the GCG device 110 causes to be expressed as nodes in the graph database 120, and uses the conclusions generated in the edges to determine an outcome. The information generated in the edges of the graph database 120 will be discussed in more detail below.

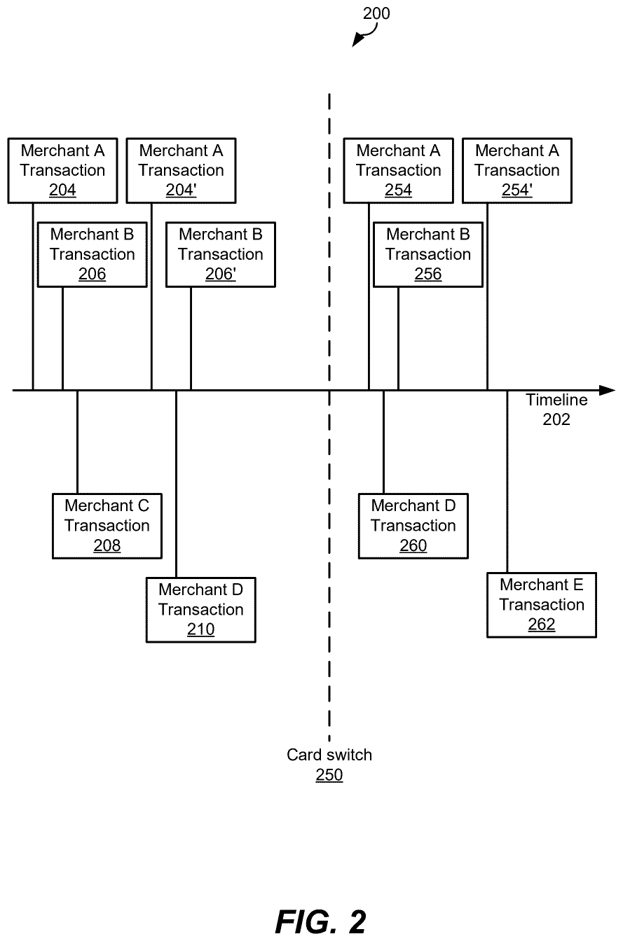

FIG. 2 illustrates an example scenario 200 of a user's transactional spending patterns that provides context for how a GCG device 110 may generate graph database components to link the user's different accounts together. This example scenario 200 shows the user's spending transactions with various merchants A, B, C, D, and E, over time, as shown on the timeline 202. In the beginning of the timeline 202, the user may conduct transaction 204 with merchant A using a baseline payment card. For example, merchant A may be a subscription service that the user has agreed to pay a recurring monthly subscription fee to. The user then conducts a transaction with merchant B at transaction 206, which may be utility service as a different example. The user may then conduct a transaction with merchant C at transaction 208, which may be at a grocery store, as another example. Then, in a recurring fashion, the user conducts a transaction again with merchant A at transaction 204′ for the same type of transaction as before. This may be consistent with merchant A being a subscription service. The user may then conduct a transaction with merchant D at transaction 210, which may be for a movie or a concert, as some examples. Then, the user may conduct another transaction with merchant B at transaction 206′, which may be another utility service payment. In this example, all of these transactions are conducted using the same payment card with a single transactional account. In other words, the user may perform many transactions, some recurring and some as one-offs, using a top of wallet card. With a single payment card, the user forms a transactional account history that contains some spending patterns that become clearer with a longer payment history.

At 250 in the timeline 202, the user changes the top of wallet payment card for some reason. This may be because the user unfortunately lost the top of wallet card, the user may have acquired a payment card with better benefits, or because the user's payment card may have expired, as just a few examples. For whatever reason, the user stops generating any other transactional history with the original top of wallet card, which may be referred to herein as the user's baseline payment card. The user then needed to form a new transactional account associated with the new top of wallet card. The user intends to use the new card just like the old one, where the recurring payments to merchants A and B remain the same and the user may still frequent the same types of other merchants on a periodic basis. These types of transactions will now show in the transactional history of the new transactional account associated with the new top of wallet card going forward after the time of the card switch 250.

So as can be seen, after this clear delineation of the card switch 250, the user continues to make transactions with merchant A at transactions 254 and 254′. The user continues to make transactions with merchant B at transaction 256, and presumably would be more as the timeline 202 goes along. The user has continued to make transactions with merchant D which an occasional or non-recurring transaction 260. The user also makes a transaction with a new merchant E at transaction 262 that was not in the transaction history of the baseline top of wallet payment card, while the user has not yet made a transaction with merchant C since the card switch.

To a processing network that processes the transactions between the various merchants and the two payment cards of the same user, it is actually not always the case that the processing network knows that the two payment cards belong to the same user. While this timeline 202 may illustrate a clear common spending pattern for the spending habits of a single user, millions or even billions of transactions are processed every day from millions or billions of users, and the processing network cannot easily discern this timeline 202 and determine that the transactions of two separate payment cards actually belong to the same user. However, with this scenario in mind, aspects of the present disclosure provide solutions for how an entity like a processing network can efficiently make this determination, especially at scale for millions of users that may be in a similar situation such as the scenario 200 at various points in their lives.

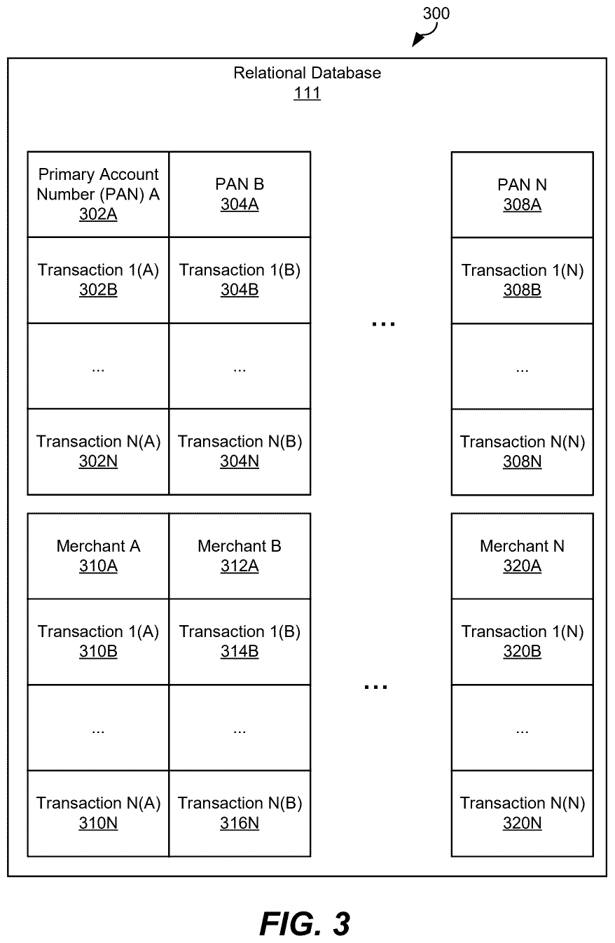

Referring to FIG. 3, illustration 300 shows a schematic of example details in relational database 111 that corresponds to the example scenario shown in FIG. 2. To capture the activity happening in FIG. 2, a relational database may be populated to store the different transactional accounts tied to the payment cards used. Here in illustration 300, the Primary Account Number (PAN) A 302A may correspond to the first payment card used in the first half of the transaction history shown in FIG. 2. The PAN B 304A may correspond to the second payment card used in the second half of the transaction history shown in FIG. 2. The relational database 111 may of course contain many more PANs, up to PAN N 308A as shown, where N may be any arbitrarily large number. Typically, a relational database of a processing network may contain millions or billions of PANs.

Linked to the PAN A 302A may be a series of transactions made with PAN A 302A. These are shown as transactions 1(A) 302B through transaction N(A) 302N, where N is any integer greater than 0 to represent the total transactions made or at least recorded with that PAN in the relational database. In this example, transaction 1(A) 302B may correspond to the first transaction 204 made with merchant A shown in FIG. 2. A subsequent transaction 2(A) (not shown) may correspond to transaction 206 with merchant B in FIG. 2, while a third stored transaction 3(A) (not shown) may correspond to transaction 208 made with merchant C, and so on. The final transaction stored, transaction N(A) 302N, may correspond to the last transaction 206′ made with merchant B before the user stopped using that payment card, in the example scenario of FIG. 2.

Similarly, linked to the PAN B 304A may be a series of transactions made with PAN B 304A. These are shown as transactions 1(B) 304B through transaction N(B) 304N, where N is any integer greater than 0 to represent the total transactions made or at least recorded with that PAN in the relational database. In this example, transaction 1(B) 304B may correspond to the first transaction 254 made with merchant A that occurred after the card switch, shown in FIG. 2. A subsequent transaction 2(B) (not shown) may correspond to transaction 260 with merchant D in FIG. 2, while a third stored transaction 3(B) (not shown) may correspond to transaction 256 made with merchant B, and so on. The final transaction stored, transaction N(B) 304N, may correspond to the last transaction 262 made with merchant E before the timeline ends, in the example scenario of FIG. 2. Over time, presumably the user would make more transactions with this second PAN and more transactions would be appended in the relational database 111 tied to PAN B 304A.

PAN N 308A has linked to it some number of transactions 1(N) 308B through N(N) 308N, representing the total number of transactions recorded in the relational database for this PAN. This format would similarly follow for all other PANs in between.

Additionally, the relational database 111 includes merchant A 310A, merchant B 312A, and so on through the last merchant N 320A that represent all merchants that utilize the processing network. By way of example, the merchants A, B, C, D, and E in FIG. 2 may respectively correspond to merchant A 310A, merchant B 312A, and so on up to merchant E, not shown. Linked to each merchant entry in the relational database 111 are the transactions made with that merchant, such as transaction 1(A) 310B through transaction N(A) 310N for merchant A 310A. These transactions are with any and all PANs, not just the two PANs shown in FIG. 2. Similarly, transaction 1(B) 314B through transaction N(B) 316N are all the transactions made with merchant B 312A, and transaction 1(N) 320B through transaction N(N) 320N are all the transactions made with merchant N 320A. It may therefore be apparent that the relational database 111 may contain billions of entries across all PANs and all merchant IDs. While the relational database 111 may therefore include an impressive amount of information, trying to find relationships between independent entries (e.g., between two different PANs or two different merchants) is computational burdensome and realistically impractical using the given format of the way the relational database stores information.

Indeed, even just using the simple example scenario of FIG. 2, where a single user decided to switch cards for whatever reason, if the relational database did not natively contain some linked entry to communicate that the two PANs belonged to the same user, it should be apparent to those with skill in the art that the format of the relational database provides no computational feasible way to determine which two accounts among all the PANs should be linked to the same user. In theory, one may want to find the two PANs with the most common spending patterns, but the relational database 111 provides no database entry or format to facilitate this operation. Rather, a new computational structure through the user of a graph database is much better suited to perform this analysis.

To illustrate the computational inefficiency or even impracticality of relying on a relational database to perform these similarity measurements, a PAN may be defined as p0, and the objective is to find the other PANs p1, p2, . . . pn that share the most merchant IDs in common with p0. To find all of the merchants (merchant IDs) that p0 transacted with, the system may need to select each MID from a giant transactional table in the relational database, for every transaction that was made by p0. These can be defined as m01, m02, . . . m0k. This is defined as query 1. Then, the second steps is the system needs to find all the PANs that transacted any of m01, . . . m0k to get the other PANs p1, . . . pj. This is another query of a giant transactional table, but it is really k queries, one for each MID that transacted with p0.

As a third step, therefore, for each of p1, . . . pn, the system needs to find all the merchants those PANs transacted at to get:
m11, m12, . . . m1k1;
m21, m22, . . . m2k2;
.
.
.
ml1, ml2, . . . mlk2.

The number of nested queries is now 2. The complexity increases as a factor of x=the number of transactions in the table. This implies that we have to search a space of x\hat{ }2 rows and, even for a small set of transactions like 1,000,000, the search space now has cardinality 1,000,000\hat{ }2=1,000,000,000,000 rows. This is just for one PAN the system wants to try to match. For each set of merchants from the third step, the system now must find out the overlap between that set and the set m01, . . . m0k. It should be apparent to persons of skill in the art that very quickly, this becomes computationally infeasible in a relational database.

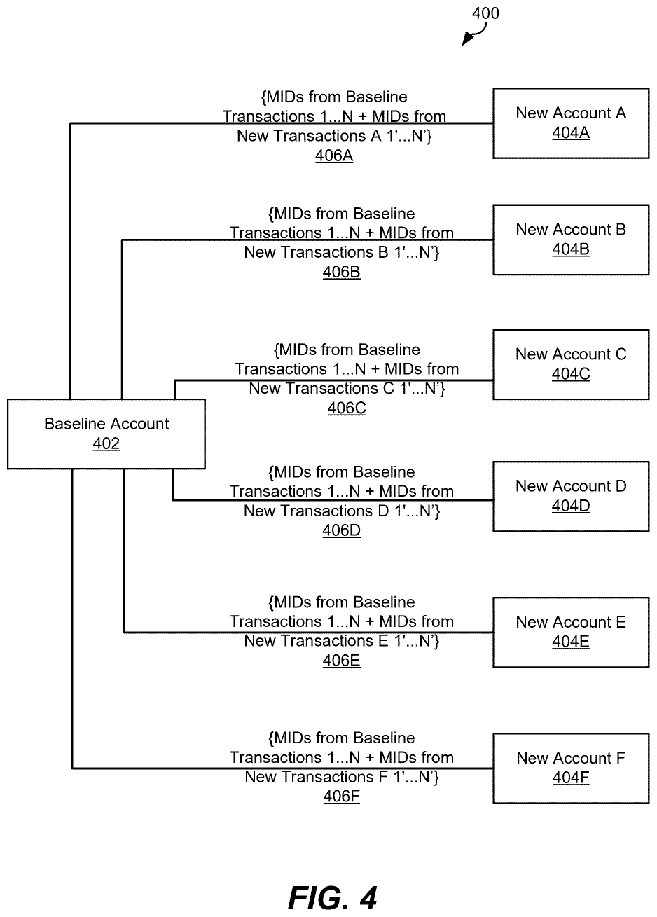

Referring to FIG. 4, illustration 400 shows several nodes and edges of an example graph database that can be used by a device (such as GCG device 110) to help determine if two transactional accounts should be linked to the same user, according to some embodiments. The graph database, such as graph database 120, contains nodes and edges connecting the nodes. The nodes generally may represent any object, person or location, but for the purposes of this disclosure, the nodes are populated with different PAN transactional accounts. The graph database provides a structure to efficiently organize an initial or baseline transactional account, that was used as a top of wallet account, with multiple new transactional accounts and provide informative relationships between the baseline transactional account and the new transactional accounts.

As shown, a node may include the baseline transactional account 402, which may correspond to the initial top of wallet account that a user utilized regularly for most spending. This is consistent with the scenario of FIG. 2 and the first payment card that the user used for most of the spending. In that example scenario, the user switched to a different payment card for some reason, and now a processing network or other system desires to determine which new account opened after the time of the card switch should be linked to the same user. This is reflected in the graph database as shown in illustration 400. Six nodes in the graph database are created by the GCG device 110 and are populated with six new accounts A 404A, B 404B, C 404C, D 404D, E 404E, and F 404F, that represent six example new transactional accounts that were opened after the user made the card switch (see FIG. 2). The information about the baseline account 402 and the new accounts 404A through 404F may be extracted from a relational database (see FIG. 3) that may be customarily populated with such information by a processing network whenever new accounts are opened with that processing network. As mentioned, however, the information stored and organized in the relational database alone is computational unsuitable and inefficient for determining whether two accounts can be linked to the same user, and instead this information may be extracted from the relational database and used to generate the graph database as shown in illustration 400 as an example.

The issue is that the processing network does not know which of these six new accounts 404A through 404F, if any, belong to the same user with the baseline account 402. To make this determination, the GCG device 110 may update the graph database with edges connecting the baseline account 402 to each of the new accounts 404A through 404F. The GCG device 110 will generate a computation in each edge that will provide information for evaluating whether any of the new account nodes 404A through 404F ought to be linked to the same user with the baseline account 402.

As an example computation, the GCG device 110 will extract the merchant transaction history of the baseline account 402 from the relational database. See for example, the transactions 302B through 302N of PAN A 302A in FIG. 3. This information may include the merchant IDs (MIDs) of each merchant that the baseline account conducted transactions with. This information may also include amounts spent from the baseline account on each merchant transaction, as well as dates of the transactions and other geographical information. For one edge, the GCG device 110 will also extract the merchant transaction history of a new transaction account, for example new account A 404A, from the relational database. See for example, the transactions 304B through 304N of PAN B 304A in FIG. 3. This information may include the merchant IDs (MIDs) of each merchant that the new account A conducted transactions with. This information may also include amounts spent from the new account on each merchant transaction, as well as dates of the transactions and other geographical information. Again, this account is designated as “new” because it was an account that was opened only after the user stopped using the baseline account 402.

The edge connecting the baseline account 402 to new account A 404A may include all of the MIDs from both the transactional history of the baseline account 402 and the new account A 404A. This is reflected as reference 406A. Similarly, these operations are conducted for the other edges between baseline account 402 and new accounts 404B through 404F. Therefore, each edge will include the MIDs from the transactional history of the baseline account, plus the MIDs from the respective transactional history of the associated new account 404B through 404F, which are denoted by respective references 406B, 406C, 406D, 406E, and 406F.

With the relationships between the nodes now established by the information populated in the edges, in some embodiments, the GCG device 110 may now perform analysis using the information in the edges to determine how similar the baseline account 402 is to each of the nodes of the new accounts 404A through 404F. Conceptually, the baseline account 402 may be more similar to a new account the more that the new account's spending pattern looks like the baseline account's spending pattern. This may be referred to as comparing the “merchant fingerprint” of the baseline account to the “merchant fingerprint” of the new account. For example, referring back to the example scenario in FIG. 2, the spending pattern of the user's new account after the user made the card switch (see transactions 254 through 262) looked similar to the transaction history of the initial baseline account in that both accounts made regular payments to merchants A and B, and both accounts conducted a transaction at merchant D. The transaction histories are not identical, however, because the user conducted a transaction at merchant C while the user did not yet do so with the new account. Plus, the user also made a transaction at merchant E that was not in the baseline account's transaction history. Thus, the two accounts had similar but not identical merchant fingerprints.

Referring back to FIG. 4, the GCG device 110 may perform the same type of similarity analysis for each edge connecting the baseline account node 402 to the new accounts 404A through 404F. Once that analysis is completed for all relevant edges, the GCG device 110 may make a determination that the edge with the highest similarity score may be an account that should be linked to the same user as the baseline account 402. In other embodiments, the GCG device 110 may transmit a communication to the user of the baseline account 402 to verify if the node of the new account with the highest similarity score in its edge belongs to that user, or may send a similar communication to the user for the top three accounts with the highest similarity score, or the like. In other cases, the GCG device may only make a conclusion that an account may belong to the same user as the baseline account 402 if the similarity measurement for its related edge rises above or satisfies some similarity metric threshold. Once a definitive determination is made, the GCG device 110 may update the graph database to note which node(s) can be linked to the same user of the baseline account 402.

Aspects of the present disclosure offer several different ways of analyzing the edges of the graph database to determine how similar the new account node may be from the baseline account node. For example, in some embodiments, the GCG device may compute a numerical score representing how many MIDs overlap as the same—and different—between the baseline account and the new account. For example, the edge's score may increment by 1 for every MID that is common between the two transaction histories, and may decrement by 1 for every MID that is different. As a variant, the edge's score may start incrementing by 1 for the first MID that is common between the two transaction histories, and then may increase the increment by 1 for each subsequent common MID, meaning that for the second MID that is common, the score increases by 2, and increases by 3 for the third common MID, and so on. This scoring may reflect a compounding likelihood of similarity when there are increasingly more MIDs that are in common.

As another example, the MIDs may be weighted based on an inverse relationship to how common or ubiquitous they are in the market. Conceptually, certain merchants that are commonly used by more people, such as a widespread streaming service or a widely used subscription service, should be afforded far less weight than a merchant that is in a niche market or only located in a single location. That is, the uniqueness of a MID ought to be weighted more for a determination of similarity. Thus, in some embodiments, the similarity measurement may utilize a weighting of the MIDs analogous to the statistical concept of term frequency inverse document frequency (TF-IDF), which may be defined as the calculation of how relevant a word in a corpus is to the overall text based on how unique or common the word typically is. The more infrequent a word appears in normal text, the more relevant that word is to its overall relevance to that text, and similarly the inverse is also applied. In this same way, the more infrequent a MID appears in all transaction histories overall, the more weight that MID may be given for determining how similar two accounts may be to one another.

As another example, the similarity score may be augmented or modified based on amounts of spending at each MID in the two transaction histories. For example, if a MID to a subscription service offers different tiers of services at different prices, the exact amount the two accounts paid for their subscription services may offer an additional clue to how similar the accounts are. As another example, if there is a MID to a landlord that is common between the two accounts and the monthly payment happens to be exactly the same, reflecting the same amount of rent, this may provide a stronger indication that the two accounts may belong to the same user.

Again, the same type of similarity measurement calculation may be conducted for each edge connecting to the baseline account node 402. Once each edge has a computed similarity measurement, the new account with the highest score may be transmitted to the user of the baseline account to see if that new account should be linked to the same user. In other cases, some subset of accounts may be transmitted to the user for verification, or if none of the measurements rise above some predetermined threshold score, none of the accounts may be determined to be linked to the user.

In FIG. 4, shown is only a single example in a graph database of how to link one baseline account node to possibly one or more new accounts by generating edges between the nodes and performing the aforementioned calculations. However, the graph database may be updated to perform this type of calculation any number of times for any number of baseline accounts. Any account may determined to be a baseline account once the account stops conducting any transactions with it, for whatever reason. In this way, it can be seen that this type of analysis may need to be performed on millions of baseline accounts stored in a relational database. However, it is much more computationally efficient to transfer the information from the relational database and generate these relationships in the graph database in order to make these determinations. This is generally because the information needed to make a linking determination is based on a relationship between data, rather than the data themselves. Despite its name, the relational database is better suited to simply record the information rather than find connections or relationships between the recorded information.

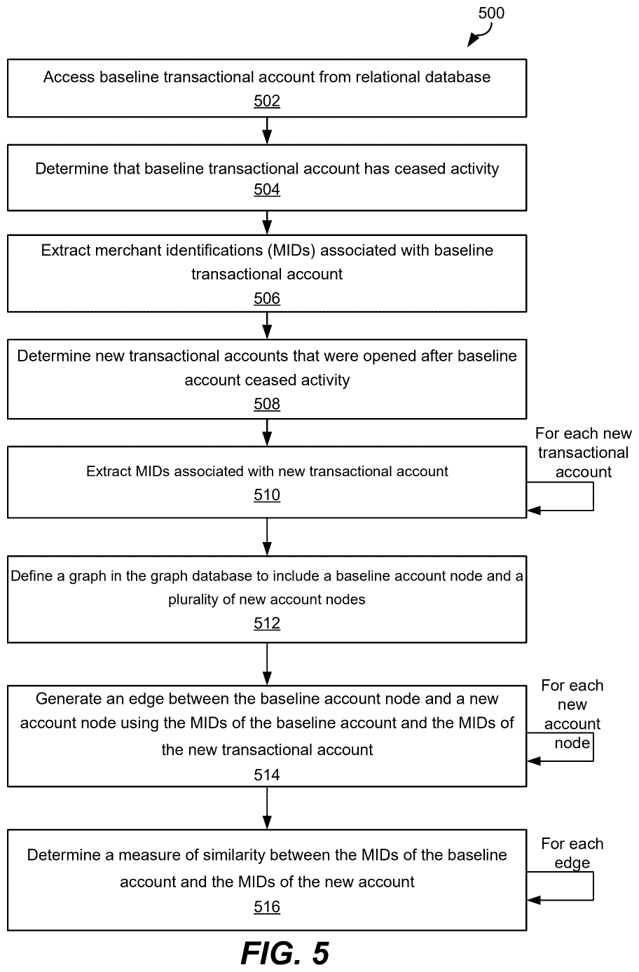

FIG. 5 illustrates an example of a method 500 for generating components in a graph database to determine a measure of similarity between a baseline transactional account and one or more new transactional accounts, according to some embodiments. The steps described in the example method 500 may be consistent with the descriptions in FIG. 4 and the supporting example illustrations in FIGS. 1, 2, and 3. This method may be performed by a system, such as the system 100 described in FIG. 1, and more specifically by a GCG device 110 as described in FIG. 1.

At 502, the system 100 or GCG device 110 may access a baseline transactional account from a relational database. As previously mentioned, the baseline account is a spending account that stopped conducting transactions after a certain point in time, for any number of reasons. This may be because the user lost the payment card associated with the account, the user picked up a new top of wallet account with better benefits, or the baseline account expired and was no longer valid. Therefore, at 504, the system 100 or GCG device 110 may determine that the baseline transactional account has ceased conducting any transactional activity with merchants.

At 506, the system 100 or GCG device 110 may extract merchant identifications (MIDs) associated with the baseline transactional account. An example of these are the MIDs associated with the transactions 302B through 302N in FIG. 3, or the MIDs associated with the merchant transactions conducted in the baseline account of FIG. 2 before the card switch.

At 508, the system 100 or GCG device 110 may determine or identify any or all new transactional accounts that were opened after the baseline account ceased activity. The objective is to determine which of these newly opened accounts, if any, were opened by the same user as the baseline transactional account so that the two accounts can be linked to the same user. Example new accounts are the new accounts 404A through 404F in FIG. 4, where the goal is to find which of these, if any, may be the actual new account opened by the user, such as the new account in FIG. 2 made after the card switch. These new transactional accounts may be extracted or identified from the relational database.

At 510, the method includes a repeating loop that performs this step for each new transactional account. The system 100 or GCG device 110 may extract the MIDs associated with the new transactional account. An example of this information includes the MIDs associated with each transactions 1(B) 304B through N(B) 304 N for PAN B 304A, and the MIDs associated with each transaction 1(N) 308B through N(N) 308N) for PAN N, where presumably each PAN B through N are new transactional accounts.

With all this information, at 512, the system 100 or the GCG device 110 may define a graph in the graph database to include a baseline account node and a plurality of new account nodes. The baseline account node may be populated with the baseline transactional account, the new account nodes may be populated with each respective new transactional account. This is consistent with the descriptions in FIG. 4.

At 514, the method includes a repeating loop that performs this step for each new account node in the graph database populated by each respective new transactional account. The system 100 or GCG device 110 may generate an edge between the baseline account node and the new account nodes using the MIDs of each transaction from the baseline account and the MIDs of each transaction from the new transactional account. This is consistent with the type of information populated in the edges of FIG. 4, see references 406A through 406F.

At 516, the method includes a repeating loop that performs this step for each edge formed between the baseline account node and each new account node. The system 100 or GCG device 110 may then determine a measure of similarity between the MIDs of the baseline account and the MIDs of the respective new account. Examples techniques for computing the measure of similarity are described above in the description of FIG. 4, and embodiments are not limited to any particular technique. Once the measure of similarity has been computed for each edge, the results may be to determine if any new account should be linked to the baseline account as having been opened by the same user. Variants on how this determination may be made are also discussed above in the description of FIG. 4.

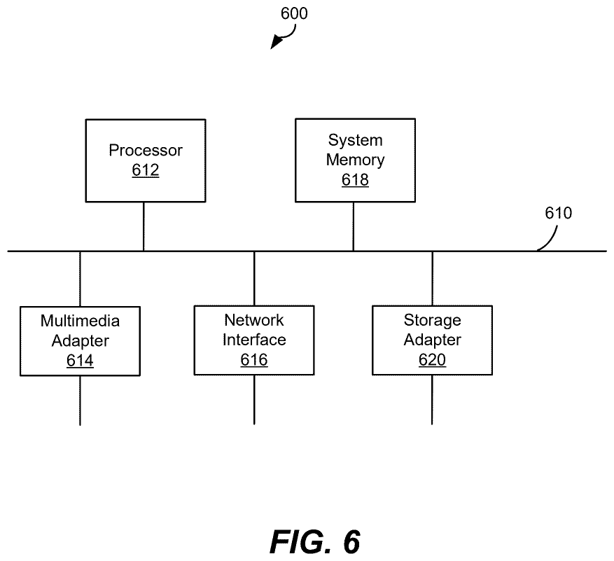

FIG. 6 illustrates an example of a computer system 600 that may be implemented by devices illustrated in FIG. 1. The computer system 600 may be part of or include the system environment 100 to perform the functions and features described herein. For example, various ones of the devices of system environment 100 may be implemented based on some or all of the computer system 600. The computer system 600 may include, among other things, an interconnect 610, a processor 612, a multimedia adapter 614, a network interface 616, a system memory 618, and a storage adapter 620.

The interconnect 610 may interconnect various subsystems, elements, and/or components of the computer system 600. As shown, the interconnect 610 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 610 may allow data communication between the processor 612 and system memory 618, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 612 may control operations of the computer system 600. In some examples, the processor 612 may do so by executing instructions such as software or firmware stored in system memory 618 or other data via the storage adapter 620. In some examples, the processor 612 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 616 may provide the computer system 600 with an ability to communicate with a variety of remote devices over a network. The network interface 616 may include, for example, an Ethernet adapter, a Fibre Channel adapter, and/or other wired- or wireless-enabled adapter. The network interface 616 may provide a direct or indirect connection from one network element to another, and facilitate communication to and between various network elements. The storage adapter 620 may connect to a standard computer readable medium for storage and/or retrieval of information, such as a fixed disk drive (internal or external).

Other devices, components, elements, or subsystems (not illustrated) may be connected in a similar manner to the interconnect 610 or via a network. The devices and subsystems can be interconnected in different ways from that shown in FIG. 6. Instructions to implement various examples and implementations described herein may be stored in computer-readable storage media such as one or more of system memory 618 or other storage. Instructions to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

“Artificial intelligence” refers to is a branch of computer science focused on training computer models via machine learning techniques to perform tasks, such as email address classification. Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The databases (such as 111 and 120, which may store various entities and facts about the entities) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process may also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of generating graph data components stored in a graph database, the method implemented using a graph component generator computing device in communication with the graph database, the graph component generator computing device including one or more processors in communication with a memory, the method comprising:
accessing a baseline transactional account from a relational database;
determining that the baseline transactional account has ceased conducting transactional activity after a first time instance;
extracting a baseline set of merchant identifications from the relational database that each conducted a transaction with the baseline transactional account;
determining a set of new transactional accounts from the relational database that were opened after the first time instance;
for each transactional account in the set of new transactional accounts, extracting from the relational database a set of respective new merchant identifications that each conducted a transaction with the respective new transactional account;
defining a graph in the graph database to include a baseline account node and a plurality of new account nodes, the baseline account node representing the baseline transactional account and each of the plurality of new account nodes representing a respective new transactional account from the set of new transactional accounts;
generating a set of edges between the baseline account node and each of the plurality of new account nodes, each edge of the set of edges defining a relationship between the baseline transactional account and the respective new transactional account represented by the respective new account node;
wherein each relationship includes the set of baseline merchant identifications and the set of respective new merchant identifications that conducted a transaction with the respective new transactional account that is represented by the respective new account node;
updating the graph in the graph database with the set of edges;
for each edge in the set of edges, determining, using the updated graph, a measure of similarity between the set of baseline merchant identifications and the set of respective new merchant identifications that conducted a transaction with the respective new transactional account; and
transmitting, to a user of the graph database, the measure of similarity for each edge in the set of edges.

2. The method of claim 1, wherein determining the measure of similarity, for each edge, includes determining an amount of merchant identifications that are found in both the set of the baseline merchant identifications and the set of respective new merchant identifications.

3. The method of claim 1, wherein determining the measure of similarity, for each edge, includes weighting each merchant identification in the set of baseline merchant identifications and the set of respective new merchant identifications.

4. The method of claim 3, wherein the weighting is based on an inverse relationship of how many transactions are conducted with each merchant identification based on all transactions in the relational database associated with said merchant identification.

5. The method of claim 3, wherein the weighting is based on TF/IDF.

6. The method of claim 1, wherein determining the measure of similarity, for each edge, includes determining amounts of spending associated with each merchant identification in the set of baseline merchant identifications and the set of respective new merchant identifications.

7. The method of claim 1, wherein determining the measure of similarity, for each edge, includes determining frequencies of spending associated with each merchant identification in the set of baseline merchant identifications and the set of respective new merchant identifications.

8. A system for generating graph data components stored in a graph database, the system comprising:
a graph component generator computing device comprising:
at least one processor;
at least one memory storing the graph database and accessible to the at least one processor;
the processor configured to:
access a baseline transactional account from a relational database;
determine that the baseline transactional account has ceased conducting transactional activity after a first time instance;
extract a baseline set of merchant identifications from the relational database that each conducted a transaction with the baseline transactional account;
determine a set of new transactional accounts from the relational database that were opened after the first time instance;
for each transactional account in the set of new transactional accounts, extract from the relational database a set of respective new merchant identifications that each conducted a transaction with the respective new transactional account;
define a graph in the graph database to include a baseline account node and a plurality of new account nodes, the baseline account node representing the baseline transactional account and each of the plurality of new account nodes representing a respective new transactional account from the set of new transactional accounts;
generate a set of edges between the baseline account node and each of the plurality of new account nodes, each edge of the set of edges defining a relationship between the baseline transactional account and the respective new transactional account represented by the respective new account node;
wherein each relationship includes the set of baseline merchant identifications and the set of respective new merchant identifications that conducted a transaction with the respective new transactional account that is represented by the respective new account node;
update the graph in the graph database with the set of edges;
for each edge in the set of edges, determine, using the updated graph, a measure of similarity between the set of baseline merchant identifications and the set of respective new merchant identifications that conducted a transaction with the respective new transactional account; and
transmit, to a user of the graph database, the measure of similarity for each edge in the set of edges.

9. The system of claim 8, wherein to determine the measure of similarity, the processor is further configured to, for each edge, determine an amount of merchant identifications that are found in both the set of the baseline merchant identifications and the set of respective new merchant identifications.

10. The system of claim 8, wherein to determine the measure of similarity, the processor is further configured to, for each edge, weight each merchant identification in the set of baseline merchant identifications and the set of respective new merchant identifications.

11. The system of claim 10, wherein the weight is based on an inverse relationship of how many transactions are conducted with each merchant identification based on all transactions in the relational database associated with said merchant identification.

12. The system of claim 10, wherein the weight is based on TF/IDF.

13. The system of claim 8, wherein to determine the measure of similarity, the processor is further configured to, for each edge, determine amounts of spending associated with each merchant identification in the set of baseline merchant identifications and the set of respective new merchant identifications.

14. The system of claim 8, wherein to determine the measure of similarity, the processor is further configured to, for each edge, determine frequencies of spending associated with each merchant identification in the set of baseline merchant identifications and the set of respective new merchant identifications.

15. A non-transitory computer readable medium, configured to be stored in a memory that, when executed by a processor, cause the processor to perform instructions comprising:
accessing a baseline transactional account from a relational database;
determining that the baseline transactional account has ceased conducting transactional activity after a first time instance;
extracting a baseline set of merchant identifications from the relational database that each conducted a transaction with the baseline transactional account;
determining a set of new transactional accounts from the relational database that were opened after the first time instance;
for each transactional account in the set of new transactional accounts, extracting from the relational database a set of respective new merchant identifications that each conducted a transaction with the respective new transactional account;
defining a graph in the graph database to include a baseline account node and a plurality of new account nodes, the baseline account node representing the baseline transactional account and each of the plurality of new account nodes representing a respective new transactional account from the set of new transactional accounts;
generating a set of edges between the baseline account node and each of the plurality of new account nodes, each edge of the set of edges defining a relationship between the baseline transactional account and the respective new transactional account represented by the respective new account node;
wherein each relationship includes the set of baseline merchant identifications and the set of respective new merchant identifications that conducted a transaction with the respective new transactional account that is represented by the respective new account node;
updating the graph in the graph database with the set of edges;
for each edge in the set of edges, determining, using the updated graph, a measure of similarity between the set of baseline merchant identifications and the set of respective new merchant identifications that conducted a transaction with the respective new transactional account; and
transmitting, to a user of the graph database, the measure of similarity for each edge in the set of edges.

16. The non-transitory computer readable medium of claim 15, wherein determining the measure of similarity, for each edge, includes determining an amount of merchant identifications that are found in both the set of the baseline merchant identifications and the set of respective new merchant identifications.

17. The non-transitory computer readable medium of claim 15, wherein determining the measure of similarity, for each edge, includes weighting each merchant identification in the set of baseline merchant identifications and the set of respective new merchant identifications.

18. The non-transitory computer readable medium of claim 17, wherein the weighting is based on an inverse relationship of how many transactions are conducted with each merchant identification based on all transactions in the relational database associated with said merchant identification.

19. The non-transitory computer readable medium of claim 17, wherein the weighting is based on TF/IDF.

20. The non-transitory computer readable medium of claim 15, wherein determining the measure of similarity, for each edge, includes determining amounts of spending associated with each merchant identification in the set of baseline merchant identifications and the set of respective new merchant identifications.

21. The non-transitory computer readable medium of claim 15, wherein determining the measure of similarity, for each edge, includes determining frequencies of spending associated with each merchant identification in the set of baseline merchant identifications and the set of respective new merchant identifications.
